(19) United States
(12) Patent Application Publication
(10) Pub. No.: US 2025/0280003 A1
(43) Pub. Date: Sep. 4, 2025

(54) MANAGING ACCOUNT PERMISSIONS FOR SOFTWARE SERVICES

(71) Applicant: Zilla Security, Inc., Boston, MA (US)

(72) Inventors: Matthew Peairs, Medford, MA (US); Nitin Sonawane, Belmont, MA (US)

(21) Appl. No.: 19/049,197

(22) Filed: Feb. 10, 2025

Related U.S. Application Data
(60) Provisional application No. 63/560,093, filed on Mar. 1, 2024.

(51) Int. Cl. H04L 9/40

(52) U.S. Cl. CPC H04L 63/102

(57) ABSTRACT

An apparatus for managing permissions for user accounts at first and second software-service providers that provide corresponding first and second account portals that comprise information about user accounts and corresponding permissions thereof. Such an apparatus includes plural sitemaps, a web crawler, and a browser extension. The plural sitemaps comprising a first sitemap constructed from the first account portal. The a browser extension, which is for a browser that accesses the first account portal, determines that the first sitemap is present and causes the web crawler to use the first sitemap to extract the information from the first account portal and to build a table based on the information.

This application claims priority to U.S. Provisional Application No. 63/560,093, filed on Mar. 1, 2024, the content of which is hereby incorporated by reference in its entirety.

### FIELD OF INVENTION

The invention relates to computer security and in particular to the management of account permissions across different providers of software services.

### BACKGROUND

A typical company uses many software services in the course of managing its business. These include services for managing human resources and payroll, services for tracking progress of various tasks, services for marketing and sale, and many others.

For each such software service, the company maintains a set of accounts with a corresponding service provider. For each such account, there exists a permission set. The permission set indicates the extent to which that account is able to access that software service. These accounts are then associated with individual employees of the company.

A company's employee population is fluid. Employees begin employment and end it, sometimes involuntarily. During an employee's career, that employee's duties and responsibilities change. As a result, it becomes necessary to create accounts, to delete accounts, and to change permissions on accounts.

As part of maintaining security, it is common for a company to periodically audit its accounts with each service provider. This requires knowing the state of all accounts and their respective permission sets.

Some, but not all providers of software services make it possible to export a file that lists user accounts and corresponding permission sets. An example of such a file is a comma-separated value file.

Some, but not all, providers make it possible to aggregate and manage accounts and their corresponding permission sets through existing application programming interfaces (APIs), file downloads, and other internal processes.

By far the most common way that a provider makes information about user accounts and corresponding permission sets available is via an account portal. Such an account portal is typically implemented by a web page. As a result, a web browser is the tool of choice for inspecting the account portal.

However, although the account portal is easy to access, collecting information for use in a census from such an account portal is difficult. The difficulty arises in part because there is no standard for the arrangement of that information.

Because the account portal is implemented as a web page, it is a simple matter to cut and paste information from the web page. However, because of the lack of a standard, the resulting pasted information will appear different for different account portals. This makes management across multiple account portals from multiple service providers somewhat burdensome.

### SUMMARY

In one aspect, the invention features an apparatus for managing permissions for user accounts at first and second software-service providers that provide corresponding first and second account portals that comprise information about user accounts and corresponding permissions thereof. Such an apparatus includes plural sitemaps, a web crawler, and a browser extension. The plural sitemaps comprising a first sitemap constructed from the first account portal. The browser extension, which is for a browser that accesses the first account portal, determines that the first sitemap is present and causes the web crawler to use the first sitemap to extract the information from the first account portal and to build a table based on the information. The apparatus is a non-abstract apparatus.

Some embodiments further include a sitemap builder. In in response to having determined that no sitemap is available for the second account portal, the extension causes the sitemap builder to solicit input from a human auditor, to construct a second sitemap based at least in part on the input, and to store the sitemap. Among these embodiments are those in which the user input comprises a selection by the auditor of a particular species of information from the second account portal.

Still other embodiments include a preview module that is configured to display the table. Among these are embodiments in which the preview module is further configured to transmit the table to an external service provider.

In another aspect, the invention features a method that includes managing permissions for user accounts at first and second software-service providers that provide corresponding first and second account portals, respectively. These account portals include information about user accounts and corresponding permissions thereof. The process of managing permissions includes constructing a first sitemap from the first account portal and using a browser extension for a browser to access the first account portal, to determine that the first site map is present, and to cause a web crawler to use the first sitemap to extract the information from the first account portal and to build a table based on the information.

Practices of the method include those in which, in response to having determined that no sitemap is available for the second account portal, using the extension to cause a sitemap builder to solicit input from a human auditor, to construct a second sitemap based at least in part on the input, and to store the sitemap. Among these are practices in which the input comprises a selection by the auditor of a particular species of information from the second account portal.

Still other practices include causing a preview module to display the table, to transmit the table to an external service provider, or both.

The implementation described herein is a non-abstract implementation. Description of an abstract version of the implementation has been omitted. As such, the claims should be construed to encompass only non-abstract embodiments. Applicant, acting as his own lexicographer, hereby defines “non-abstract” as the converse of “abstract” as that term has been defined and used by the courts of the United States as of the filing date of this application. Any person who construes the claims as reading on abstract subject matter would therefore be construing the claims contrary to the specification.

### BRIEF DESCRIPTION OF THE FIGURES

FIG. 1 shows software used for collecting information from multiple software-service providers.

### DETAILED DESCRIPTION

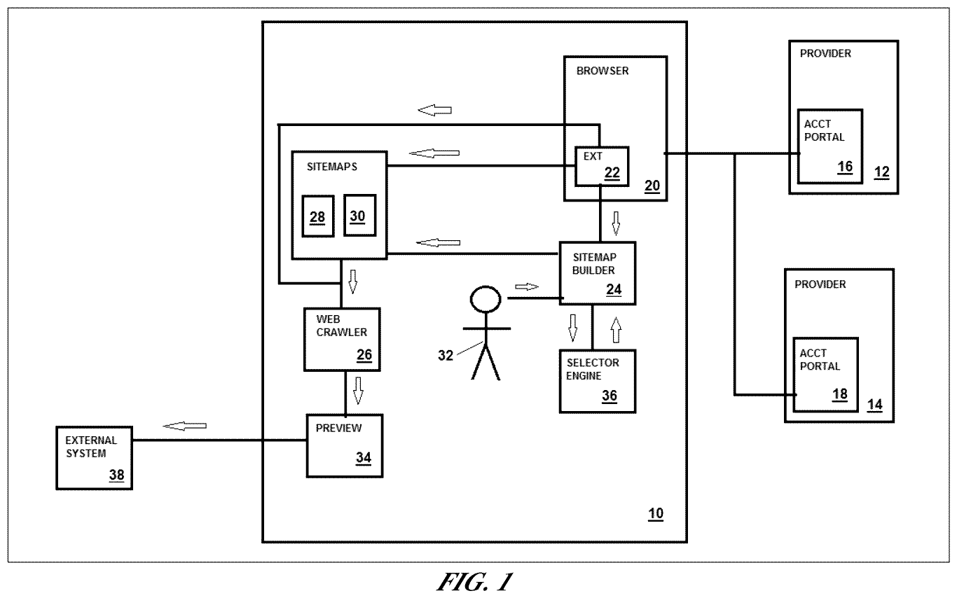

FIG. 1 shows a company 10 that maintains a relationship with first and second software-service providers 12, 14, hereafter referred to as “providers” for brevity. The first provider 12 maintains a first account-portal 16. The second provider 14 maintains a second account-portal 18. Each account portal 16, 18 shows accounts and permissions associated with accounts at the corresponding provider 12, 14.

Of course, in practice, a company 10 may have relationships with more than two such providers 12, 14. However, for any set of providers 12, 14 with a cardinality of two or more, there will always be first and second providers 12, 14. Therefore, based on mathematical induction, there is no loss of generality in discussing only two such providers 12, 14.

Accordingly, for simplicity and ease of exposition, this disclosure will describe the case of only first and second providers 16, 18.

A typical account portal 16, 18 is implemented as a web page that is accessible to a browser 20 at the company 10. The browser 20 includes an extension 22 that interacts with both a sitemap builder 24 and a web crawler 26 and a set of sitemaps, which in the illustrated example includes a first sitemap 28 that corresponds to the first account-portal 16 and a second sitemap 30 that corresponds to the second account-portal 18.

An account portal 16, 18 comprises consumable information and structural information. The consumable information comprises the user accounts and their respective permission sets. It is this information that is of most interest to the company 10. The structural information controls how the consumable information is displayed on the two-dimensional expanse of the web page. This structural information is different across different account-portals 16, 18. As a result, account portals 16, 18 maintained by different service providers 12, 14 look different from each other.

In a typical account portal 16, 18, the structural information is embodied in text that is delimited by special characters to form “tags.” The consumable information takes the form of objects (often text), each of which is associated with one or more tags. Among the tasks of a browser 10 is to use these tags to determine where each item of consumable information will ultimately be displayed. This results in a tidy and organized display, at least as long as one is using the browser 20.

In many cases, it is useful to extract information from the account portal 16, 18 and to place it into some canonical format that is more convenient for the company 10.

The process of extracting consumable information from a web page is somewhat more difficult than it seems. One approach is to use a browser's ability to copy and paste. But this requires manual intervention. In addition, the results of doing so with different account-portals 16, 18 will differ, thus making standardization into a canonical format more difficult.

A typical web crawler 26 is adept at collecting both consumable information and structural information. However, a difficulty that arises is that the web crawler 26 has no way of knowing the meaning of whatever consumable information it has extracted. After all, structural information, such as tags, only describes what to do with tagged information, not what it is. The first and second sitemaps 28, 30 address this difficulty.

The use of sitemaps 28, 30 takes advantages of three properties of the account portal 16, 18. First, there exist different species of consumable information, examples of which include the username and each of the various permissions. Second, each species is associated with a tag. Third, for a given service provider 12, 14, the tag associated with a species of consumable information remains constant for extended periods of time. After all, a service provider 12, 14 has better things to do than modify the formatting of its account portal 16, 18.

For each species of consumable information, the first sitemap 28 stores an association between that species and the tag that the first account-portal 16 uses to tag that species. Similarly, for each species of consumable information, the second sitemap 30 stores an association between that species and the tag that the second account-portal 18 uses to tag that species.

In operation, a human auditor 32 uses the browser 20 to navigate to the first account-portal 16. Once there, the auditor 32 clicks the extension's icon in the browser's navigation bar. The extension 22, having recognized that it is the first account-portal 16 that is of interest, searches the set of available sitemaps for a corresponding sitemap, which in this case is the first sitemap 28.

At this point, there are two possibilities: either the first sitemap 28 exists, or it does not exist.

If the first sitemap 28 exists, the extension 22 provides the web crawler 26 with the first sitemap 28. The web crawler 26 uses the first sitemap 28 to parse the hierarchical structure of the first account-portal 16. This enables it to recognize the particular species of each item of consumable information. As a result, the web crawler 26 is able to create a record corresponding to each account identified on the first account-portal 16. thereon. In some embodiments, the web crawler 26 collects additional data. This occurs when not all user accounts are on the same page of the first account-portal 16.

The web crawler 26 supports two modes of operation, one in which the display is paginated and one in which it is not. In either case, the web crawler 26 simulates user clicks or scrolling to iterate through all available records in the first account-portal 16.

With the records having been created and placed in a table, the extension 22 causes a preview module 34 to show the table, for example as a modal dialog overlaid on the display of the first account-portal 16. At this point, the auditor 32 has the option of exporting both the consumable and the first sitemap 28 to an external service 38 for further processing.

In some cases, the first sitemap 28 does not exist. As a result, it must be brought into existence. This is carried out by the sitemap builder 24 with some assistance from the auditor 32.

The sitemap builder 24 appears as a sidebar overlaid on the display. The various visual and interactive elements of the sidebar are added using CSS and JAVASCRIPT injection.

The sitemap builder 24 provides a user interface that guides the auditor 32 step-by-step through the process of generating a first sitemap 28 that can later be used by the web crawler 26 to collect the structured consumable information from the first account-portal 16.

For each species of consumable data, (e.g., account email, account permissions, date of last login, etc.) the sitemap builder 24 asks the auditor 32 to identify an example of a particular species of consumable information on the first account-portal 16. For example, the sitemap builder 24 might ask the auditor 32 to click on a username or to hover a pointer over the username and press a particular key, such as “S” for “select.” The sitemap builder 24 provides feedback to confirm the auditor's selection. An example of such feedback is a dotted red outline around the auditor's selection.

Once the auditor 32 has confirmed the selection, it is provided to a selector engine 36. The selector engine 36 generates a “selector” that uniquely identifies the elements corresponding to the species of consumable information represented by the selection. This results in a set of selectors, one for each species of consumable information. The sitemap builder 24 uses these selectors to construct the first sitemap 28.

Upon completion of the sitemap construction process, the first sitemap 28 is sent to the web crawler 26, which proceeds to use it as discussed above for the case in which the first sitemap 28 existed all along.

A system along the lines described herein enables the company 10 to reduce the time required to extract extracting permissions and accounts from every provider 12, 14 and to do so accurately, regardless of internal details of the applications implemented by the provider 12, 14. Moreover, the system permits central management of accounts while omitting the need to integrate the various applications with a central directory. The availability of sitemaps 28, 30 tuned to each account portal 16, 18 also makes the extraction of consumable information from each account portal 16, 18 reliable and repeatable.

Having described the invention and a preferred embodiment thereof, what is claimed as new and secured by Letters Patent is:

1. An apparatus for managing permissions for user accounts at first and second software-service providers, said first and second software providers providing corresponding first and second account portals that comprise information about user accounts and corresponding permissions thereof, said apparatus comprising plural sitemaps, said plural sitemaps comprising a first sitemap constructed from said first account portal, a web crawler, and a browser extension for a browser that accesses said first account portal, wherein said browser extension determines that said first sitemap is present, and causes said web crawler to use said first sitemap to extract said information from said first account portal and to build a table based on said information.

2. The apparatus of claim 1, further comprising a sitemap builder, wherein, in response to having determined that no sitemap is available for said second account portal, said extension causes said sitemap builder to solicit input from a human auditor, to construct a second sitemap based at least in part on said input, and to store said sitemap.

3. The apparatus of claim 2, wherein said user input comprises a selection by said auditor of a particular species of information from said second account portal.

4. The apparatus of claim 1, further comprising a preview module that is configured to display said table.

5. The apparatus of claim 4, wherein said preview module is further configured to transmit said table to an external service provider.

6. The apparatus of claim 1, further comprising a preview module that is configured to display said table and to transmit said table to an external service provider.

7. The apparatus of claim 1, further comprising a preview module that is configured to display said table and to transmit said table to an external service provider, a sitemap builder, wherein, in response to having determined that no sitemap is available for said second account portal, said extension causes said sitemap builder to solicit input from a human auditor, to construct a second sitemap based at least in part on said input, and to store said sitemap, wherein said user input comprises a selection by said auditor of a particular species of information from said second account portal.

8. A method comprising managing permissions for user accounts at first and second software-service providers that provide corresponding first and second account portals, respectively, said account portals comprising information about user accounts and corresponding permissions thereof, wherein managing said permissions comprises constructing a first sitemap from said first account portal and using a browser extension for a browser to access said first account portal, to determine that said first site map is present, and to cause a web crawler to use said first sitemap to extract said information from said first account portal and to build a table based on said information.

9. The method of claim 8, wherein, in response to having determined that no sitemap is available for said second account portal, using said extension to cause a sitemap builder to solicit input from a human auditor, to construct a second sitemap based at least in part on said input, and to store said sitemap.

10. The method of claim 9, wherein said input comprises a selection by said auditor of a particular species of information from said second account portal.

11. The method of claim 8, further comprising causing a preview module to display said table.

12. The method of claim 8, further comprising causing a preview module to transmit said table to an external service provider.

13. A manufacture comprising a tangible and non-transitory computer-readable medium having encoded thereon instructions for causing a computing system to manage permissions for user accounts at first and second software-service providers that provide corresponding first and second account portals, respectively, said account portals comprising information about user accounts and corresponding permissions thereof, wherein said instructions comprise instructions for constructing a first sitemap from said first account portal and using a browser extension for a browser to access said first account portal, to determine that said first site map is present, and to cause a web crawler to use said first sitemap to extract said information from said first account portal and to build a table based on said information.
